(19) United States
(12) Patent Application Publication
(10) Pub. No.: US 2015/0017327 A1
(43) Pub. Date: Jan. 15, 2015

(54) TWO-COMPONENT HANDHELD SPRAY GUN

(71) Applicant: L&P PROPERTY MANAGEMENT COMPANY, SOUTH GATE, CA (US)

(72) Inventors: TERRANCE L. MYERS, JOPLIN, MO (US); GREG KOEHLER, JOPLIN, MO (US); MATTHEW SMALLWOOD, JOPLIN, MO (US)

(21) Appl. No.: 14/327,021

(22) Filed: Jul. 9, 2014

Related U.S. Application Data
(60) Provisional application No. 61/845,206, filed on Jul. 11, 2013.
(60) Provisional application No. 61/932,068, filed on Jan. 27, 2014.

(51) Int. Cl. B05B 7/12; B05B 12/00; C09J 5/00; B05B 7/08

(52) U.S. Cl. CPC B05B 7/1209; B05B 7/0846; B05B 12/002; C09J 5/00; C09J 2205/30
USPC 427/207.1; 239/414

(57) ABSTRACT

Systems and methods for resolving inefficiencies when applying spray adhesive and activator from a two-component, handheld spray gun are provided. One embodiment of the two-component, handheld spray gun apparatus includes a first nozzle and a second nozzle coupled to a common bracket. The first nozzle and the second nozzle each include a spray valve and orifice for dispensing an amount of liquid adhesive or liquid activator from the respective nozzle using only line pressure. Further, a trigger coupled to the first and second nozzles is used to simultaneously dispense the adhesive and activator during spraying. In embodiments, the first and second nozzles dispense adhesive and activator at a particular angle such that an amount of dispersed adhesive intersects an amount of dispersed activator to provide a combined spray pattern on a surface.

### CROSS-REFERENCE TO RELATED APPLICATIONS

This application claims priority to U.S. Provisional Application No. 61/845,206, filed Jul. 11, 2013, entitled “Two-Component Handheld Spray Gun,” having attorney docket number LGPL.189214, and to U.S. Provisional Application No. 61/932,068, filed Jan. 27, 2014, entitled “Two-Component Handheld Spray Gun,” having attorney docket number LGPL.203047, the entire disclosure of both of which is hereby incorporated by reference.

### STATEMENT REGARDING FEDERALLY SPONSORED RESEARCH OR DEVELOPMENT

None.

### BACKGROUND OF THE INVENTION

When assembling two or more articles (e.g., assembling foam rails on a foam sheet in the industrial field of furniture, bedding, and/or mattress manufacturing) using adhesion, operators have increasingly relied upon applying fast-acting spray adhesives. These spray adhesives serve as both an effective glue-type material for joining articles together, while at the same time allowing for efficiencies during fabrication. In some instances, the spray gun dispenses both a liquid adhesive and a liquid activator that cannot be mixed in a spray chamber before exiting the spray gun because a mixed solution could clog the spray gun as the adhesive starts to “set up.” To prevent clogging, compressed air is typically used to separately atomize a liquid adhesive and a liquid activator, which are then combined during spraying before contacting a surface.

Various problems exist with these atomizing-type spray guns that utilize compressed air to disperse the liquid adhesive and liquid activator. For example, atomizing-type spray guns create an inconsistent application of the spray adhesive on the intended article(s), producing a misdirected, airborne spray of adhesive that contacts items not intended to receive the spray adhesive. In some instances, the compressed air blows the adhesive and activator at such a high velocity that it becomes airborne. Not only does the atomizing process produce a less accurate spray, but the applied mixture itself provides minimal surface coverage with a narrow spray/fan pattern. Additionally, the nozzles and/or tips of existing spray guns using compressed air fail to create an even distribution of activator across the adhesive stream from a dual-headed spray system. Accordingly, embodiments of the present invention introduce technology for resolving the above-mentioned issues conventionally experienced when applying spray adhesive from a spray gun.

### BRIEF SUMMARY OF THE INVENTION

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The embodiments of the present invention relate broadly to innovative systems and methods for resolving inefficiencies when applying spray adhesive and activator from a two-component, handheld spray gun.

Embodiments of the innovative systems include a two-component, handheld spray gun apparatus with a first tip for dispensing liquid adhesive and a second tip for dispensing liquid activator. In embodiments, the first tip and second tip simultaneously disperse the liquid adhesive and liquid activator such that the spray from each tip converges to form a layer of adhesive and activator on a surface. Based on the positioning of the first tip with respect to the second tip, the components of the first tip and the second tip, and the amount of line pressure applied to the liquid adhesive and the liquid activator, embodiments of the handheld spray gun produce a combined application of liquid adhesive and liquid activator having a consistent spray pattern covering a defined area.

As such, the innovative methods include simultaneously dispensing a liquid adhesive and a liquid activator from a two-component, handheld spray gun using line pressure. In embodiments of the method, the line pressure applied to the liquid adhesive and the liquid activator is constant, while the components of the first and second tip may vary to provide a desired concentration and/or ratio of liquid adhesive that intersects liquid activator during spraying of the handheld spray gun. As such, a combined application pattern of liquid adhesive and liquid activator covering a defined area on a surface is generated using line pressure.

In an exemplary embodiment, the two-component, handheld spray gun apparatus includes a central housing with a first tip and a second tip coupled to the central housing. The first tip includes a first spray valve and a first orifice, with the first spray valve allowing an amount of liquid adhesive to be dispersed from the first tip using only line pressure. The second tip coupled to the central housing includes a second spray valve and a second orifice, with the second spray valve allowing an amount of liquid activator to be dispersed from the second tip using only line pressure. In the embodiment of the handheld spray gun, the first tip is positioned with respect to the second tip such that liquid adhesive dispersed from the first tip intersects the liquid activator dispersed from the second tip during spraying of the handheld spray gun.

In other embodiments, a method for application of a liquid adhesive and a liquid activator using a two-component, handheld spray gun is provided. The method includes applying line pressure to a liquid adhesive and a liquid activator coupled to a handheld spray gun. The method further includes simultaneously dispersing: (1) an amount of the liquid adhesive from a first tip using only the line pressure, the first tip including a first orifice and a first spray valve, and (2) an amount of the liquid activator from a second tip using only the line pressure, the second tip comprising a second orifice and a second spray valve. In embodiments, the line pressure dispersing the liquid adhesive and the liquid activator is constant. Additionally, the dispersed liquid adhesive intersects the dispersed liquid activator during spraying of the handheld spray gun to produce a combined application pattern of liquid adhesive and liquid activator covering a defined area on a surface.

In yet another embodiment, a two-component, handheld spray gun apparatus includes a central housing coupled to a first and second tip. The first tip coupled to the central housing includes a first spray valve, a first orifice, and a liquid adhesive inlet. The first spray valve allows an amount of liquid adhesive to be dispersed from the first tip using only line pressure. The second tip coupled to the central housing includes a second spray valve, a second orifice, and a liquid activator inlet, wherein the second spray valve allows an amount of liquid activator to be dispersed from the second tip using only line pressure. The central housing includes a trigger for simultaneously controlling the first spray valve and the second spray valve, and applying pressure to the trigger causes simultaneous dispersal of the amount of liquid adhesive and the amount of liquid activator. Further, the first tip is positioned with respect to the second tip such that liquid adhesive dispersed from the first tip intersects liquid activator dispersed from the second tip during spraying of the handheld spray gun. The dispersed liquid adhesive intersects the dispersed liquid activator during spraying of the handheld spray gun to produce a combined application pattern of liquid adhesive and liquid activator covering a defined area.

In embodiments, a two-component, handheld spray gun apparatus includes a common bracket; a first nozzle coupled to the common bracket, the first nozzle comprising a first spray valve and a first orifice, wherein the first spray valve allows an amount of liquid adhesive to be dispersed from the first nozzle using only line pressure; a second nozzle coupled to the common bracket, the second nozzle comprising a second spray valve and a second orifice, wherein the second spray valve allows an amount of liquid activator to be dispersed from the second tip using only line pressure; and a trigger coupled to the first nozzle and the second nozzle, wherein the first nozzle is positioned with respect to the second nozzle such that liquid adhesive dispersed from the first nozzle intersects the liquid activator dispersed from the second nozzle during spraying of the handheld spray gun.

In a further embodiment, a method for application of a liquid adhesive and a liquid activator using a two-component, handheld spray gun is provided. The method includes applying line pressure to a liquid adhesive and a liquid activator coupled to a handheld spray gun; and simultaneously dispersing: 1) an amount of the liquid adhesive from a first nozzle of the handheld spray gun using only the line pressure, the first nozzle comprising a first spray valve and a first tip, and 2) an amount of the liquid activator from a second nozzle using only the line pressure, the second nozzle comprising a second spray valve and a second tip; wherein the line pressure dispersing the liquid adhesive and the liquid activator is constant, and further wherein the dispersed liquid adhesive intersects the dispersed liquid activator during spraying of the handheld spray gun to produce a combined application pattern of liquid adhesive and liquid activator covering a defined area on a surface.

In another embodiment, a two-component, handheld spray gun apparatus includes a common bracket; a first nozzle coupled to the common bracket, the first nozzle comprising: 1) a first spray valve, 2) a first chamber coupled to the first spray valve, and 3) a first tip coupled to the first chamber, the first tip comprising a first orifice, wherein the first spray valve allows an amount of liquid adhesive to be dispersed from the first tip using only line pressure; a second nozzle coupled to the common bracket, the second nozzle comprising: 1) a second spray valve, 2) a second chamber coupled to the second spray valve, and 3) a second tip coupled to the second chamber, the second tip comprising a second orifice, wherein the second spray valve allows an amount of liquid activator to be dispersed from the second tip using only line pressure; and a trigger configured to simultaneously control the first spray valve and the second spray valve, wherein applying pressure to the trigger causes simultaneous dispersal of the amount of liquid adhesive and the amount of liquid activator; wherein the first nozzle is positioned with respect to the second nozzle such that liquid adhesive dispersed from the first nozzle intersects liquid activator dispersed from the second nozzle during spraying of the handheld spray gun, and further wherein the dispersed liquid adhesive intersects the dispersed liquid activator during spraying of the handheld spray gun to produce a combined application pattern of liquid adhesive and liquid activator covering a defined area.

### BRIEF DESCRIPTION OF THE SEVERAL VIEWS OF THE DRAWINGS

The accompanying drawings, in which like reference numerals are used to indicate like parts in the various views, form a part of the specification and are to be read in conjunction therewith, wherein:

FIG. 1 is a perspective view of a two-component, handheld spray gun, in accordance with an embodiment of the present invention;

FIG. 2 is an enlarged, perspective view of a top, front portion of the handheld spray gun of FIG. 1, in accordance with an embodiment of the present invention;

FIG. 3 is an enlarged, perspective view of a bottom, front portion of the handheld spray gun, with a partially disassembled tip, in accordance with an embodiment of the present invention;

FIG. 4 is a cross-sectional view of a tip of the handheld spray gun, in accordance with an embodiment of the present invention;

FIG. 5 is a perspective view of an embodiment of the handheld spray gun applying adhesive and activator to a surface, in accordance with an embodiment of the invention;

FIG. 6A is a perspective view of a spray tip of a handheld spray gun, in accordance with an embodiment of the present invention;

FIG. 6B is a perspective view of a spray tip of a handheld spray gun, in accordance with an embodiment of the present invention;

FIG. 6C is a perspective view of a spray tip of a handheld spray gun, in accordance with an embodiment of the present invention;

FIG. 7 is a cross-sectional view of the handheld spray gun tip of FIG. 6A, in accordance with an embodiment of the present invention;

FIG. 8A is a perspective view of a spray tip of a handheld spray gun, in accordance with an embodiment of the present invention;

FIG. 8B is a perspective view of a spray tip of a handheld spray gun, in accordance with an embodiment of the present invention;

FIG. 8C is a perspective view of a spray tip of a handheld spray gun, in accordance with an embodiment of the present invention;

FIG. 9 is a cross-sectional view of the handheld spray gun tip of FIG. 8A, in accordance with an embodiment of the present invention;

FIG. 10 is a diagram of an exemplary method for application of a liquid adhesive and a liquid activator using a two-component, handheld spray gun, in accordance with an embodiment of the present invention;

FIG. 11 is a rear, perspective view of a two-component, handheld spray gun, in accordance with an embodiment of the present invention;

FIG. 12 is a front, perspective view of a two-component, handheld spray gun, in accordance with an embodiment of the present invention;

FIG. 13 is a side view of a two-component, handheld spray gun with a trigger in a resting position, in accordance with an embodiment of the present invention;

FIG. 14 is a side view of the two-component, handheld spray gun of FIG. 13 with a trigger in a downward, compressed position, in accordance with an embodiment of the present invention;

FIG. 15 is a side view of the two-component, handheld spray gun of FIG. 13 with a trigger in an upward, compressed position, in accordance with an embodiment of the present invention;

FIG. 16 is a cross-sectional view of a nozzle of a handheld spray gun with a lever in a resting position, in accordance with an embodiment of the present invention;

FIG. 17. is a cross-sectional view of a nozzle of a handheld spray gun, with a lever in a downward, compressed position, in accordance with an embodiment of the present invention;

FIG. 18 is a perspective view of a nozzle of a two-component, handheld spray gun, in accordance with an embodiment of the present invention;

FIG. 19 is an exploded view of the nozzle of FIG. 18, in accordance with an embodiment of the present invention; and

FIG. 20 is a perspective view of an embodiment of the handheld spray gun applying adhesive and activator to a surface, in accordance with an embodiment of the invention.

### DETAILED DESCRIPTION OF THE INVENTION

Generally, embodiments of the present invention introduce technology for providing a two-component, handheld spray gun that simultaneously disperses a first fluid (e.g., liquid adhesive) and a second fluid (e.g., liquid activator) using line pressure. The spray gun includes a first valve having a first tip for dispersing an amount of liquid adhesive, and a second valve having a second tip for dispersing an amount of liquid activator. The first and second valves are positioned with respect to each other such that a combined application pattern of the converging, dispersed fluids covers a defined area. In embodiments, a tip orifice size may be manipulated to adjust the ratio of the amount of liquid adhesive and liquid activator being sprayed. In embodiments, this technology allows for generating an evenly distributed spray pattern of activated adhesive on a surface of a subject article as well as eliminating air atomizing caused by compressed-air spraying systems.

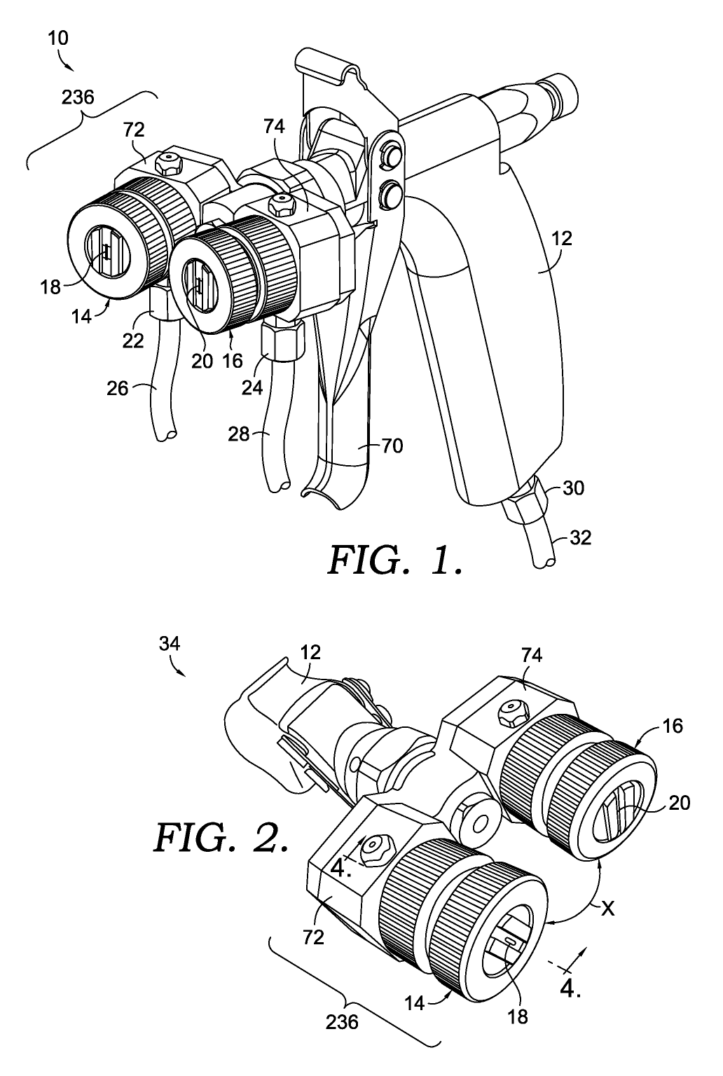

Turning now to FIG. 1, a perspective view of a two-component, handheld spray gun 10 is shown, in accordance with an embodiment of the present invention. In the embodiment illustrated in FIG. 1, the two-component, handheld spray gun 10 includes a central housing 12 coupled to a spray head 236 including a first tip 14, a second tip 16, a first orifice 18, and a second orifice 20. First tip 14 is coupled to an adhesive inlet 22 that provides liquid adhesive to the spray gun 10 via adhesive tubing 26. Further, second tip 16 is coupled to an activator inlet 24 that provides liquid activator to spray gun 10 via activator tubing 28. In one embodiment, a constant amount of line pressure is applied to the liquid adhesive and the liquid activator being dispensed from the first tip 14 and the second tip 16. As such, only line pressure is used to propel the dispersed amounts of liquid adhesive and liquid activator from the first tip 14 and second tip 16, respectively.

In the embodiment of FIG. 1, compressed air inlet 30 is coupled to the central housing 12, which provides compressed air to at least a portion of the spray gun 10 via the compressed air tubing 32. In particular, the compressed air from compressed air tubing 32 is used during operation of the trigger 70 to open or close the adhesive piston inside piston housing 72 and the activator piston inside piston housing 74. In one embodiment, a user may activate both the first tip 14 and the second tip 16 by compressing the trigger 70, allowing compressed air from compressed air tubing 32 to be supplied to a portion of the spray gun 10 configured to open the adhesive piston inside piston housing 72 and the activator piston inside piston housing 74. Having opened the adhesive and activator pistons inside their respective housings using compressed air from compressed air tubing 32, line pressure applied to a reservoir of liquid adhesive and line pressure applied to a reservoir of liquid activator may then propel the adhesive and activator solutions out of the first tip 14 and second tip 16 during spraying of the spray gun 10. In other words, while line pressure advances the liquid adhesive and liquid activator for spraying by the handheld spray gun, compressed air opens a portion of the spray gun 10 to permit travel of both the adhesive and activator liquids.

In one embodiment, spray head 236 includes the components of first tip 14 and second tip 16, and can be coupled to any number of different types of housings, triggers, bases, and the like. In one example, spray head 236 may be coupled to a housing that triggers the release of liquid activator and liquid adhesive from the spray head 236, such as a housing having a solenoid valve that selectively permits compressed air to travel through a portion of the spray head 236 to open both the piston housing 72 and the piston housing 74, and allow line pressure to disperse both the liquid adhesive and liquid activator. Additionally, although depicted in FIG. 1 as a device requiring manual manipulation by compression of the trigger 70, the trigger 70 of spray gun 10 may be any device for controlling the spray gun 10. In some embodiments, trigger 70 is a device that receives an indication of control of the spray gun 10. As such, in one embodiment, trigger 70 is a remote sensing device that receives an indication from a user to initiate spraying of the spray gun 10, such as a capacitive touchscreen input device in one exemplary embodiment. In another embodiment, trigger 70 includes a remote controller coupled to an air source that opens the pistons of spray head 236, such as by using an air cylinder having a solenoid valve for controlling the pistons of spray gun 10, thereby allowing air to pass through the spray gun 10. In a further embodiment, the spray gun 10 may include multiple triggers 70, such that a user may independently control the first tip 14 and the second tip 16 of spray head 236.

In one embodiment, the amount of line pressure applied to the liquid adhesive and liquid activator is within a range of 1 to 100 pound-force per square inch (PSI). As such, a first amount of line pressure may be applied to the liquid adhesive within the range of 1 to 100 PSI, while a second amount of line pressure may be applied to the liquid activator within the same PSI range, with the first amount of line pressure and second amount of line pressure being different amounts. Further, in another embodiment, the first amount of line pressure and second amount of line pressure may be the same.

In another embodiment of the invention, the line pressure applied to both the liquid adhesive and the liquid activator is within a range of 25 to 85 PSI (i.e., either equal amounts of line pressure applied to each liquid or varying amounts of line pressure applied to each liquid, within the 25 to 85 PSI range). Additionally, in another embodiment, the line pressure applied to both the liquid adhesive and liquid activator is 40 PSI. As such, in one embodiment, the line pressure applied to the liquid adhesive varies from the amount of line pressure applied to the liquid activator, while in another embodiment, the line pressure applied to each liquid is equivalent. As will be understood, the “simultaneous” dispersal of liquid adhesive and liquid activator includes the dispersal of each liquid at the same time but not necessarily at the same rate of dispersal.

In a further embodiment of the invention, an amount of line pressure associated with the first tip 14 may be used to propel a cleaning solution from and/or flush a cleaning solution through the first tip 14. For example, line pressure may be used to propel water through the first tip 14 during a cleaning of a residual amount of liquid adhesive from first tip 14, first orifice 18, and/or piston housing 72.

Turning to FIG. 2, an enlarged, perspective view of a top, front portion 34 of the handheld spray gun 10 of FIG. 1 is shown in accordance with an embodiment of the present invention. The front portion 34 depicts one embodiment of the invention having the first tip 14 at a particular position X with respect to second tip 16. Accordingly, the front portion 34 is configured such that a spray dispersed from first tip 14 converges and/or intersects a spray dispersed from second tip 16 to provide a combined spray pattern. In further embodiments, the position X of first tip 14 with respect to second tip 16 may be altered by adjusting the angle that each tip is positioned with respect to the central housing 12. Further, as shown in more detail in FIG. 2, the adhesive piston coupled to piston housing 72 and the activator piston coupled to piston housing 74 may be opened or closed with respect to the first tip 14 and second tip 16, respectively.

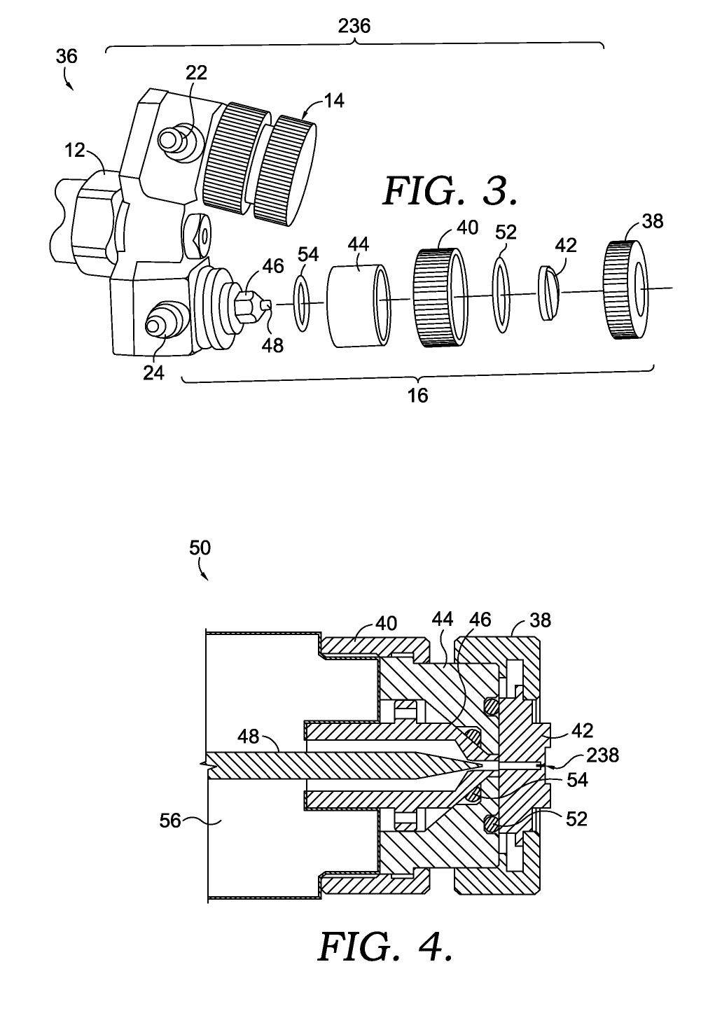

With reference now to FIG. 3, an enlarged, perspective view of a bottom, front portion 36 of the handheld spray gun, with a partially disassembled second tip 16 is shown according to an embodiment of the present invention. The front portion 36, when viewed from the bottom, depicts how adhesive inlet 22 provides a source of liquid adhesive to first tip 14 while activator inlet 24 provides a source of liquid activator to second tip 16. Components of second tip 16 are shown in FIG. 3, including a needle seat 46 housing a needle 48. As will be understood, first tip 14 has similar components as second tip 16, which are not depicted in an expanded and/or disassembled view. When in an assembled position, needle seat 46 is enclosed in the pieces of second tip 16. Second tip 16 includes a first gasket 54 and a tip ring 44 encircled at least in part, by a first collar 40. Further, the second tip 16 also includes the spray tip 42 secured by the second collar 38 and a second gasket 52. In embodiments, first collar 40 and second collar 38 are tightened into contact with the other components of second tip 16 to form a sealed device that mates to the exterior of the needle seat 46 and/or needle 48.

Accordingly, a cross-sectional view 50 of a tip of the handheld spray gun 10 is shown in FIG. 4, in accordance with an embodiment of the present invention. In the embodiment of FIG. 4, needle seat 46 is surrounded in part by tip ring 44, with first gasket 54 forming a seal between an exterior portion of needle seat 46 and an interior portion of the tip ring 44. As further depicted in FIG. 4, spray tip 42 is mated to an end surface of tip ring 44 using second collar 38, with second gasket 52 forming a seal between the spray tip 42 and the tip ring 44. In one embodiment, spray tip 42 permits the flow of liquid adhesive or activator flowing from tip body 56 around needle 48, which is dispersed through spray tip orifice 238. As such, a size of the spray tip orifice 238 may be adjusted to alter the amount of dispersed liquid adhesive or activator flowing from the spray gun 10. Similarly, an amount of dispersed liquid adhesive or activator that flows out of needle 48 (i.e., the rate of flow) may also be adjusted.

Accordingly, an opening size of the spray tip orifice 238 and/or needle 48 opening may be adjusted on each of the first tip 14 and second tip 16 to determine a particular amount of liquid dispersed from a corresponding tip. In one embodiment, the amount of liquid adhesive dispersed from first tip 14 may be different from the amount of liquid adhesive dispersed from second tip 16 over the same period of time. Accordingly, a different concentration of liquid adhesive to liquid activator is provided in the combined application pattern of spray adhesive and activator. In one embodiment, the ratio of liquid adhesive to liquid activator is between 5:1 and 7:1. In a further embodiment, the ratio of liquid adhesive to liquid activator is 6:1.

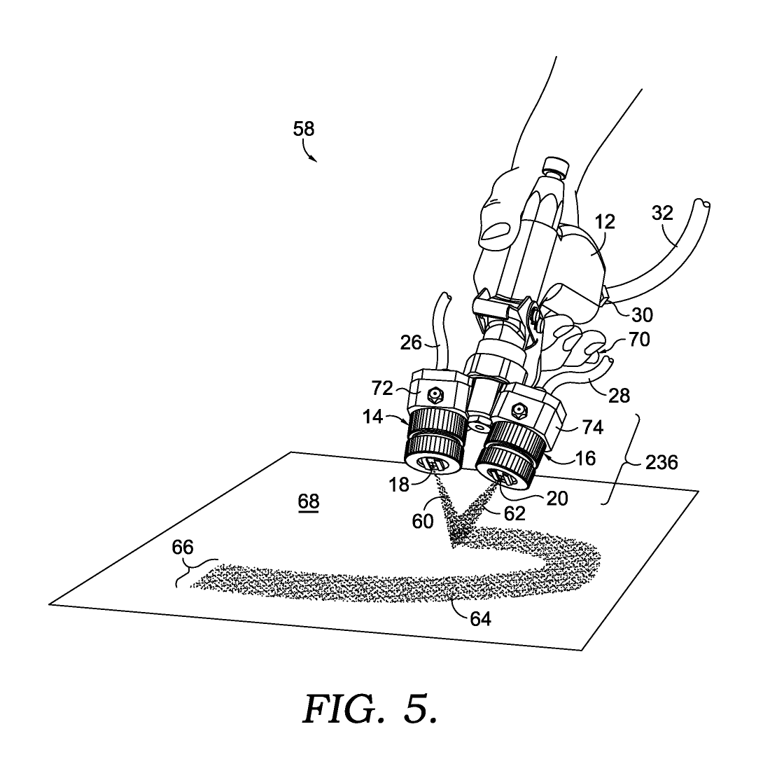

Referring next to FIG. 5, a perspective view 58 of an embodiment of the handheld spray gun 10 applying adhesive and activator to a surface is shown in accordance with an embodiment of the invention. The angled, perspective view of FIG. 5 includes the central housing 12, first tip 14, and second tip 16 aimed at a surface 68. Surface 68 may be any surface for receiving the dispersed, combined spray application of adhesive and activator, such as an interior or exterior surface of a furniture item requiring a consistent adhesive application. In embodiments of spraying the handheld spray gun 10, the dispersed liquid adhesive 60 exiting the first orifice 18 of first tip 14 converges with the dispersed liquid activator 62 exiting the second orifice 20 of the second tip 16. As such, a combined application 64 is sprayed onto the surface 68 within a defined area 66. In some embodiments, dispersed liquid adhesive 60 converges with dispersed liquid activator 62 prior to contacting the surface 68, such that one or more adhering properties of the liquid adhesive are activated by the liquid activator prior to the combined application contacting the surface 68.

In another embodiment, dispersed liquid adhesive 60 converges with dispersed liquid activator 62 at the surface 68, such that the dispersed liquid adhesive 60 contacts the dispersed liquid activator 62 at the same time that it contacts the surface 68. As such, the liquid adhesive is activated by the liquid activator at the time both liquids contact the surface 68. In a further embodiment, dispersed liquid adhesive 60 converges with dispersed liquid activator 62 at a point below the surface 68, such that either the liquid adhesive 60 or the liquid activator 62 contacts the surface 68 first, prior to the other liquid contacting the surface. For example, in one embodiment, the spray head 236 may be positioned at a particular angle with respect to the surface 68 such that the dispersed liquid adhesive 60 is applied to the surface 68 prior to when the dispersed liquid activator 62 contacts the surface 68. In that example, the liquid adhesive 60 applied to the surface 68 is activated upon receiving the dispersed liquid activator 62 within the same defined area. Accordingly, in one embodiment, the first tip 14 may be positioned with respect to the second tip 16 such that liquid adhesive dispersed from the first tip 14 intersects the liquid activator dispersed from the second tip 16 either before, at the same time, or after contacting the surface 68.

One or more features of the handheld spray gun 10 enable the spraying of a consistent, combined application 64 within a defined area 66, such as the size of first orifice 18 and/or the size of second orifice 20 to adjust a rate of dispersion of the two liquids. Further, as shown in FIGS. 2-4, the needle 48 may be adjusted to increase or decrease an amount of adhesive or activator dispersed from the first tip 14 or second tip 16, thereby providing a threshold rate of dispersion to adequately combine the two liquids, while the position X of first tip 14 with respect to second tip 16 may also be adjusted.

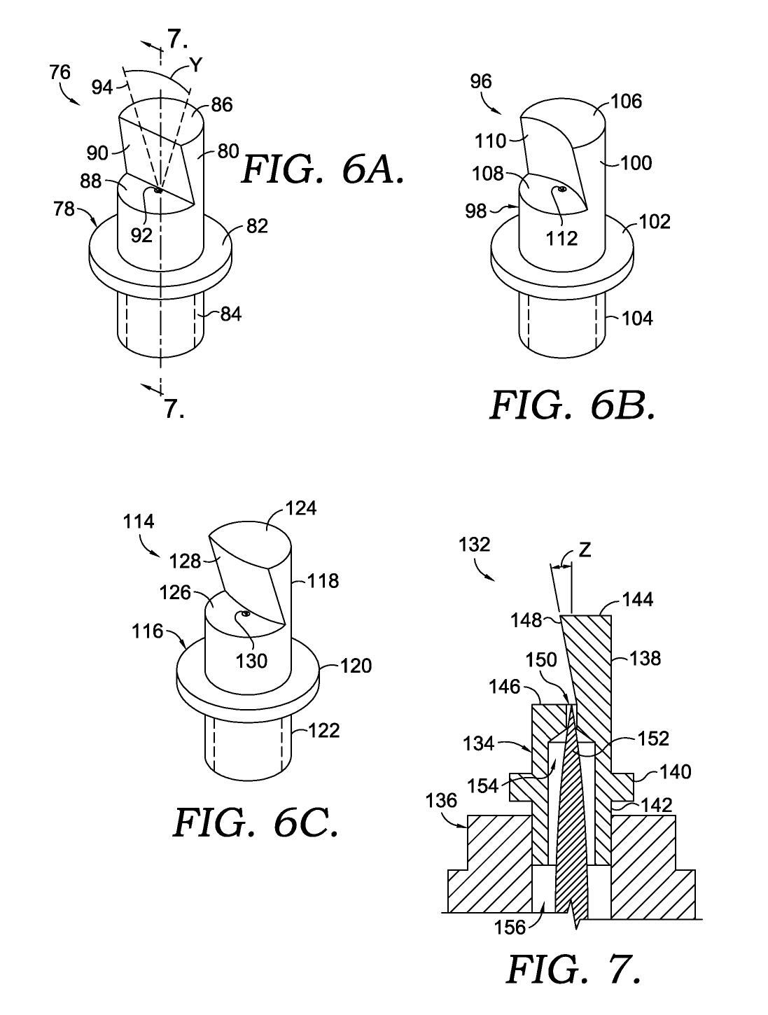

Turning now to FIG. 6A, a perspective view of a spray tip 76 of a handheld spray gun 10 is shown in accordance with an embodiment of the present invention. In some embodiments, spray tip 76 is provided in addition or as an alternative to one or more components of the first tip 14 and/or second tip 16 depicted in FIGS. 1-5. The spray tip 76 includes a tip body 78 having a top portion 80, a middle portion 82, and a bottom portion 84. As depicted in the embodiment of FIG. 6A, the tip body 78 also includes an end surface 86, a recessed surface 88, and a spray surface 90. During spraying of the handheld spray gun 10 using only line pressure, an amount of liquid activator or liquid adhesive exits the spray orifice 92 and is dispersed along at least a portion of the spray surface 90, covering a dispersed spray area 94 having a spray angle Y. As one skilled in the art will appreciate, the spray pattern (i.e., dispersed spray area 94 having a spray angle Y) created by spray tip 76 is due in part to surface characteristics of the spray surface 90, as well as the angle of spray surface 90 with respect to recessed surface 88.

In the example of FIG. 6B, a perspective view of a spray tip 96 of a handheld spray gun 10 is shown in accordance with an embodiment of the present invention. The spray tip 96 includes a tip body 98 having a top portion 100, a middle portion 102, and a bottom portion 104. As depicted in the embodiment of FIG. 6B, the tip body 98 also includes an end surface 106, a recessed surface 108, and a spray surface 110. Using line pressure, liquid adhesive or liquid activator is dispersed from spray orifice 112, contacting at least a portion of the spray surface 110 before entering the air. As shown in FIG. 6B, spray surface 110 is concave, producing a unique spray pattern with respect to the spray tip 96.

With reference to FIG. 6C, a perspective view of a spray tip 114 of a handheld spray gun 10 is shown in accordance with an embodiment of the present invention. The spray tip 114 includes a tip body 116 having a top portion 118, a middle portion 120, and a bottom portion 122. As depicted in the embodiment of FIG. 6C, the tip body 116 also includes an end surface 124, a recessed surface 126 and a spray surface 128. Using line pressure, liquid adhesive or liquid activator is dispersed from spray orifice 130, contacting at least a portion of the spray surface 128 before entering the air. As shown in FIG. 6C, spray surface 128 is convex, producing a unique spray pattern with respect to the spray tip 114.

Accordingly, FIG. 7 is a cross-sectional view 132 of the handheld spray gun 10 spray tip of FIG. 6A, depicted in accordance with an embodiment of the present invention. The cross-sectioned spray tip 134 is depicted in FIG. 7 as being nested within a portion of a housing 136, surrounding at least a portion of the spray tip 134. The spray tip 134 includes a top portion 138, a middle portion 140, and a bottom portion 142. Although top, middle, and bottom portions 138, 140, and 142 are depicted as having a particular orientation with respect to the neighboring portions of the spray tip 134, it should be understood that the diameter of top, middle, and bottom portions 138, 140, and 142 of spray tip 134 (and/or the top and bottom portions of spray tips 76, 96, and 114) are not limited by the examples of FIGS. 6A-7.

In the example of FIG. 7, spray tip 134 also includes an end surface 144, a recessed surface 146, and a spray surface 148. The spray tip 134 is designed to enclose the needle 152 within a needle seat 154 inside of the spray tip 134. As such, liquid adhesive or activator from reservoir 156 travels around needle 152 and exits orifice 150.

In the embodiment of FIG. 7, spray surface 148 is angled at a particular face angle Z with respect to a central, longitudinal axis of the spray tip 134. Accordingly, during spraying of the handheld spray gun 10 using only line pressure, an amount of liquid activator or liquid adhesive exits the spray orifice 150 and is dispersed along at least a portion of the spray surface 148 to produce a particular spray pattern. In another embodiment, face angle Z may be created based on an angling of the opening of orifice 150 relative to the spray surface 148. As such, in one embodiment, spray surface 148 may be aligned with the central, longitudinal axis of the spray tip 134, while liquid activator or liquid adhesive is sprayed at an angle from spray orifice 150 along at least a portion of the spray surface 148.

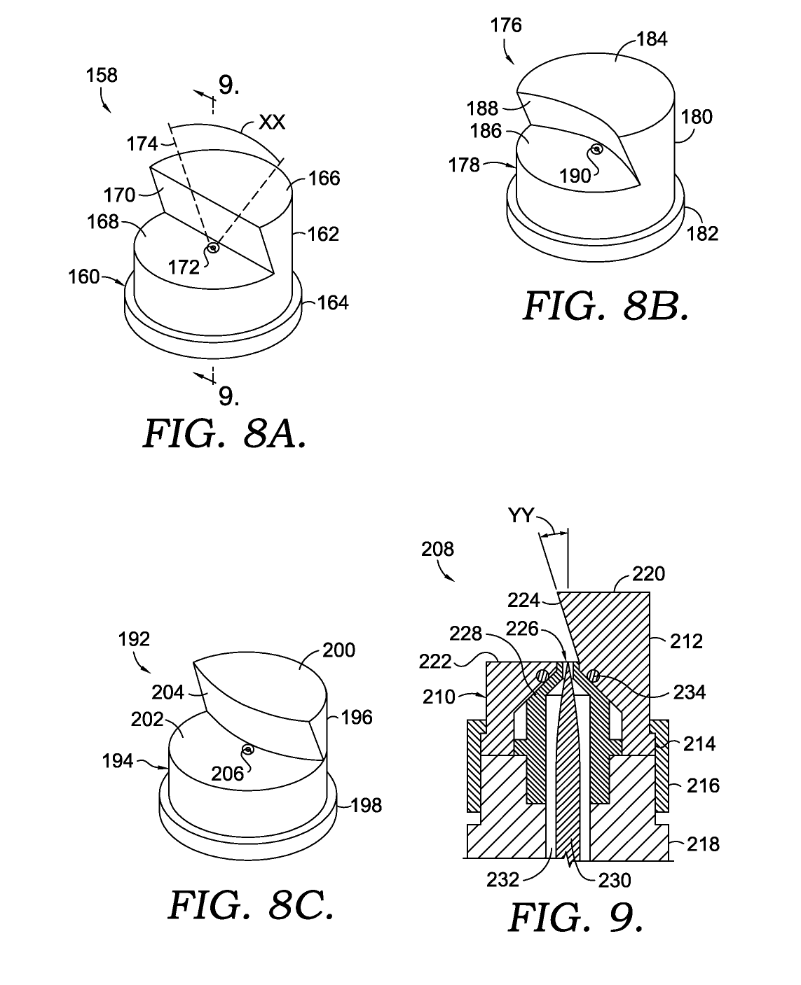

Referring next to FIG. 8A, a perspective view of a spray tip 158 of a handheld spray gun 10 is shown in accordance with an embodiment of the present invention. In some embodiments, spray tip 158 is provided in addition or as an alternative to one or more components of the first tip 14 and/or second tip 16 depicted in FIGS. 1-5. The spray tip 158 includes a tip body 160 having a top portion 162 and a bottom portion 164. As depicted in the embodiment of FIG. 8A, the tip body 160 also includes an end surface 166, a recessed surface 168, and a spray surface 170. During spraying of the handheld spray gun 10 using only line pressure, an amount of liquid activator or liquid adhesive exits the spray orifice 172 and is dispersed along at least a portion of the spray surface 170, covering a dispersed spray area 174 having a spray angle XX. As one skilled in the art will appreciate, the spray pattern (i.e., dispersed spray area 174 having a spray angle XX) created by spray tip 158 is due in part to surface characteristics of the spray surface 170, as well as the angle of spray surface 170 with respect to recessed surface 168.

Next, FIG. 8B shows a perspective view of a spray tip 176 of a handheld spray gun 10 in accordance with an embodiment of the present invention. The spray tip 176 includes a tip body 178 having a top portion 180 and a bottom portion 182. As depicted in the embodiment of FIG. 8B, the tip body 178 also includes an end surface 184, a recessed surface 186, and a spray surface 188. Using line pressure, liquid adhesive or liquid activator is dispersed from spray orifice 190, contacting at least a portion of the spray surface 188 before entering the air. As shown in FIG. 8B, spray surface 188 is concave, producing a unique spray pattern with respect to the spray tip 176.

As shown in FIG. 8C, a perspective view of a spray tip 192 of a handheld spray gun 10 is depicted according to an embodiment of the present invention. The spray tip 192 includes a tip body 194 having a top portion 196 and a bottom portion 198. As depicted in the embodiment of FIG. 8C, the tip body 194 also includes an end surface 200, a recessed surface 202, and a spray surface 204. Using line pressure, liquid adhesive or liquid activator is dispersed from spray orifice 206, contacting at least a portion of the spray surface 204 before entering the air. As shown in FIG. 8C, spray surface 204 is convex, producing a unique spray pattern with respect to the spray tip 192.

Turning next to FIG. 9, a cross-sectional view 208 of the handheld spray gun 10 spray tip of FIG. 8A is shown in accordance with an embodiment of the present invention. The spray tip 208 includes a tip body 210 having a top portion 212 and a bottom portion 214. The cross-sectioned spray tip 208 is depicted in FIG. 9 as being coupled to a collar 216, surrounding at least a portion of the spray tip 208. Although top and bottom portions 212 and 214 are depicted as having a particular orientation with respect to the neighboring portions of the spray tip 208, it should be understood that the diameter of top and bottom portions 212 and 214 of spray tip 208 (and/or the top and bottom portions of spray tips 158, 176, and 192) are not limited by the examples of FIGS. 8A-9.

In the example of FIG. 9, spray tip 208 also includes an end surface 220, a recessed surface 222, and a spray surface 224. The spray tip 208 is designed to enclose the needle 230 within a needle seat 228 inside of the spray tip 208. As such, liquid adhesive or activator from reservoir 232 travels around needle 230 and exits orifice 226. In embodiments, an O-ring and/or gasket 234 is seated between the interior of tip body 210 and the exterior of needle seat 228, providing a sealed, mated environment with the spray tip 208 coupled to the housing 218 of a spray gun 10 using collar 216.

In the embodiment of FIG. 9, spray surface 224 is angled at a particular face angle YY with respect to a central, longitudinal axis of the spray tip 208. Accordingly, during spraying of the handheld spray gun 10 using only line pressure, an amount of liquid activator or liquid adhesive exits the spray orifice 226 and is dispersed along at least a portion of the spray surface 224 to produce a particular spray pattern. In another embodiment, face angle YY may be created based on an angling of the opening of orifice 226 relative to the spray surface 224. As such, in one embodiment, spray surface 224 may be aligned with the central, longitudinal axis of the spray tip 208, while liquid activator or liquid adhesive is sprayed at an angle from spray orifice 226 along at least a portion of the spray surface 224.

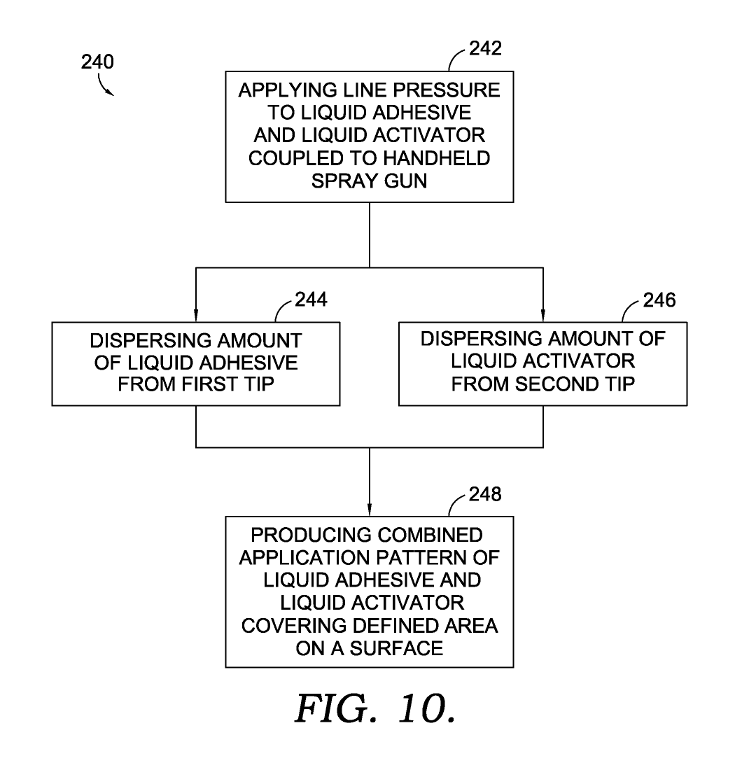

Referring next to FIG. 10, an exemplary method 240 for application of a liquid adhesive and a liquid activator using a two-component, handheld spray gun is depicted in accordance with an embodiment of the present invention. At block 242, line pressure is applied to a liquid adhesive and liquid activator coupled to a handheld spray gun. At block 244, an amount of liquid adhesive is dispersed from the first tip of the handheld spray gun, while simultaneously at block 246, an amount of liquid activator is dispersed from a second tip of the handheld spray gun. Finally, at block 248, a combined application pattern of liquid adhesive and liquid applicator is produced, covering a defined area on a surface.

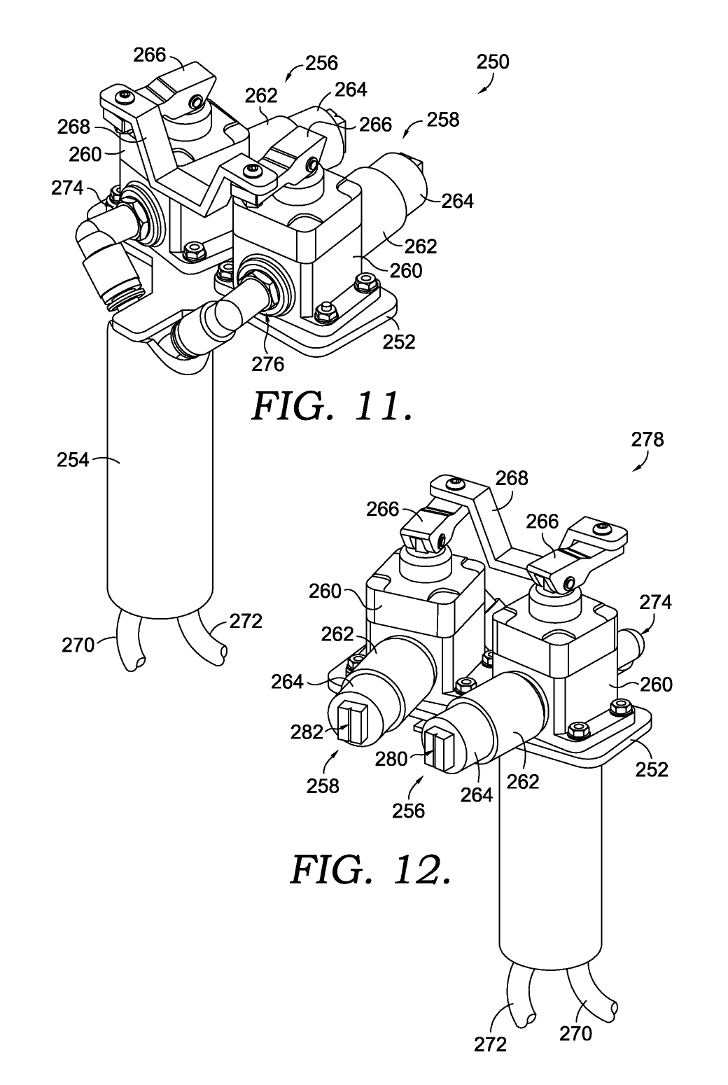

With reference to FIG. 11, a rear, perspective view of a two-component, handheld spray gun 250 is depicted in accordance with an embodiment of the present invention. The spray gun 250 includes a common bracket 252 coupled to a handle 254, a first nozzle 258, and a second nozzle 256. In embodiments, each nozzle component includes a valve 260, a chamber 262, and a tip 264. As such, activation of a lever 266 by trigger 268 causes spraying from both the first nozzle 258 and the second nozzle 256. In one embodiment, activator input 270 provides an amount of activator under line pressure to the spray gun 250, while adhesive input 272 provides an amount of adhesive under line pressure to the spray gun 250. Accordingly, activator input 270 is coupled to a valve 260 of the second nozzle 256 at joint 274, while adhesive input 272 is coupled to a valve 260 of the first nozzle 258 at a joint 276. As such, in some embodiments, activator and adhesive are simultaneously dispersed from the two-component, handheld spray gun 250 at a particular ratio, such as at a ratio within a range of 3:1 to 7:1 liquid adhesive to liquid activator. In one embodiment, the two-component, handheld spray gun disperses a combined spray having a ratio of 4:1 liquid adhesive to liquid activator.

As further shown in FIG. 12, a front, perspective view of an embodiment of the two-component, handheld spray gun 278 includes a first orifice 282 on the tip 264 of the first nozzle 258, and a second orifice 280 on the tip 264 of the second nozzle 256. In embodiments, an amount of adhesive is dispensed from the first orifice 282 of first nozzle 258 while an amount of adhesive is dispensed from the second orifice 280 of the second nozzle 256 based on depression of the bridging trigger 268 that simultaneously activates both nozzles.

In a further embodiment of the invention, an amount of line pressure associated with the first nozzle 258 may be used to propel a cleaning solution from and/or flush a cleaning solution through the first nozzle 258. For example, line pressure may be used to propel water through the first nozzle 258 during a cleaning of a residual amount of liquid adhesive from first orifice 282, a liquid adhesive chamber 262, and/or a liquid adhesive tip 264.

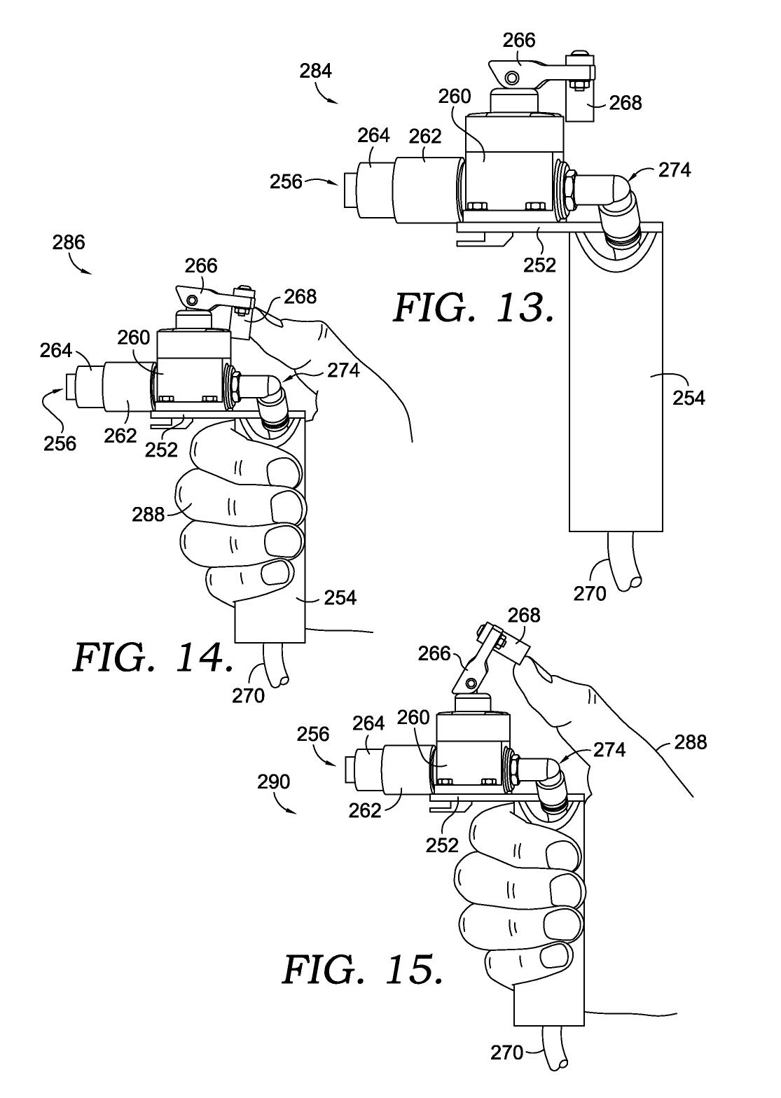

With reference to FIG. 13, a side view of a two-component, handheld spray gun 284 depicts a trigger 268 in a resting position, in accordance with an embodiment of the present invention. As shown in FIG. 14, the trigger 268 may be compressed into a downward position during spraying of the two-component, handheld spray gun 286 by a user 288. As such, based on such downward compression of the trigger 268, both valves 260 of the first and second nozzles 258 and 256 are engaged for simultaneous dispersal of liquid adhesive and activator. In a further embodiment, as shown in the side view of FIG. 15, the two-component, handheld spray gun 290 may also be sprayed based on an upward compression of the trigger 268. Accordingly, in one embodiment, upward compression of the trigger 268 causes both valves 260 of the first and second nozzles 258 and 256 to simultaneously engage for dispersal of a combined spray of liquid adhesive and activator. In one embodiment, the trigger 268 and corresponding levers 266 are compressed upward at a threshold angle of displacement, such as a 45 to 80-degree angle.

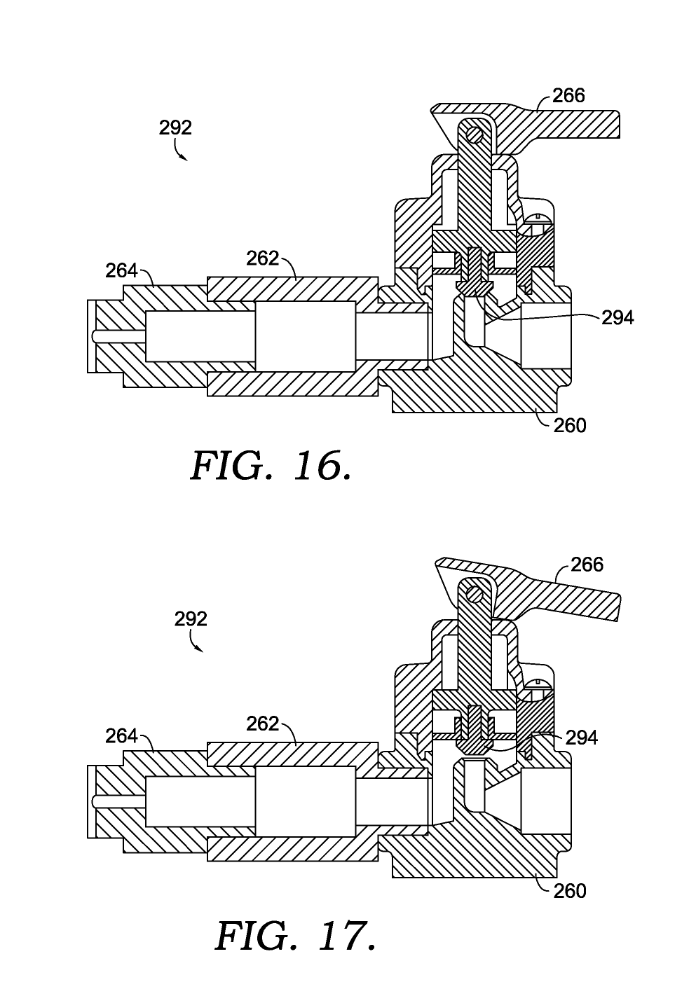

Turning now to FIG. 16, a cross-sectional view of a nozzle 292 of a handheld spray gun includes a lever 266 of a valve 260 in a resting position, in accordance with an embodiment of the present invention. As shown in the example of FIG. 16, fluid flowing from the spray gun travels into the valve 260 and is retained by diaphragm 294. In embodiments, based on compression of the lever 266 (by depressing the trigger 268 coupled to the lever 266), diaphragm 294 raises, as shown in FIG. 17, to permit fluid to flow through the valve 260. Accordingly, an amount of liquid adhesive for dispersal by first nozzle 258, or an amount of liquid activator for dispersal by second nozzle 256, is permitted to travel from the valve 260 to the chamber 262 upon activation of the diaphragm 294 of the valve 260. In some embodiments, fluid flowing through the valve 260 passes through the chamber 262 and exits the nozzle via spray tip 264 based on amount of line pressure applied to the flowing adhesive/activator.

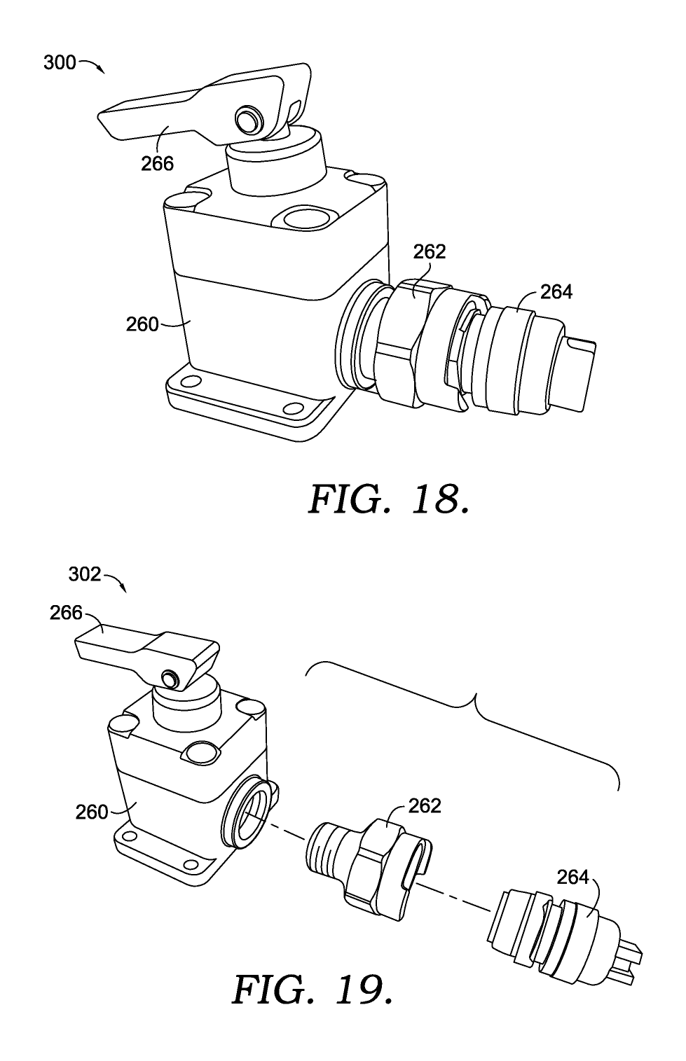

Turning next to FIG. 18, a perspective view of a nozzle 300 of a two-component, handheld spray gun depicts an embodiment of the present invention. The nozzle 300 includes a valve 260, with lever 266, coupled to a chamber 262. The chamber 262 is then coupled to the tip 264. As shown in the exploded view of the nozzle 302 of FIG. 19, the components of a nozzle in the present invention are configured to simultaneously control the dispersal of liquid adhesive or activator from adjacent nozzles both coupled to a common, bridging trigger 268. In embodiments, the bridging trigger 268 is configured to compress (e.g., downward or upward compression) the lever 266 of a valve 260 a threshold distance such that the diaphragm 294 is raised to permit the dispersal of adhesive/activator.

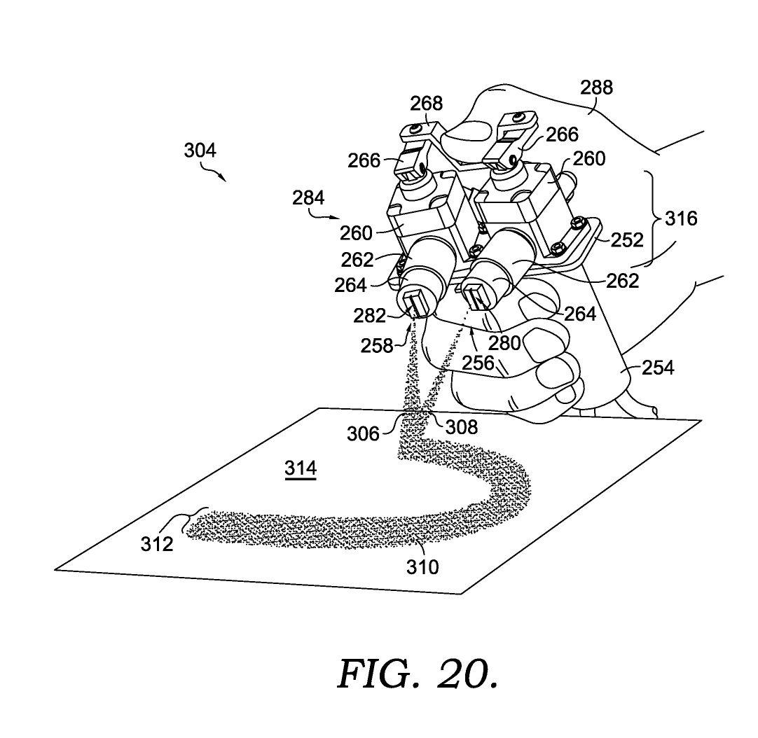

With reference finally to FIG. 20, a perspective view 304 of an embodiment of the handheld spray gun 284 applying adhesive and activator to a surface is shown in accordance with an embodiment of the invention. The angled, perspective view of FIG. 20 includes the handle 254, first nozzle 258, and second nozzle 256 aimed at a surface 314. Surface 314 may be any surface for receiving the dispersed, combined spray application of adhesive and activator, such as an interior or exterior surface of a furniture item requiring a consistent adhesive application. In embodiments of spraying the handheld spray gun 284, the dispersed liquid adhesive 306 exiting the first orifice 282 of first nozzle 258 converges with the dispersed liquid activator 308 exiting the second orifice 280 of the second nozzle 256. As such, a combined application 310 is sprayed onto the surface 314 within a defined area 312. In some embodiments, dispersed liquid adhesive 306 converges with dispersed liquid activator 308 prior to contacting the surface 314, such that one or more adhering properties of the liquid adhesive are activated by the liquid activator prior to the combined application 310 contacting the surface 314.

In another embodiment, dispersed liquid adhesive 306 converges with dispersed liquid activator 308 at the surface 314, such that the dispersed liquid adhesive 306 contacts the dispersed liquid activator 308 at the same time that it contacts the surface 314. As such, the liquid adhesive is activated by the liquid activator at the time both liquids contact the surface 314. In a further embodiment, dispersed liquid adhesive 306 converges with dispersed liquid activator 308 at a point below the surface 314, such that either the liquid adhesive 306 or the liquid activator 308 contacts the surface 314 first, prior to the other liquid contacting the surface. For example, in one embodiment, the spray head 316 may be positioned at a particular angle with respect to the surface 314 such that the dispersed liquid adhesive 306 is applied to the surface 314 prior to when the dispersed liquid activator 308 contacts the surface 314. In that example, the liquid adhesive 306 applied to the surface 314 is activated upon receiving the dispersed liquid activator 308 within the same defined area. As such, the dispersed liquid adhesive 306 may travel on a trajectory towards the dispersed liquid activator 308 with the potential to converge, but for the intersecting surface 314. Accordingly, in some embodiments, the first nozzle 258 may be positioned with respect to the second nozzle 256 such that liquid adhesive 306 dispersed from the first nozzle 258 intersects the liquid activator 308 dispersed from the second nozzle 256 either before, at the same time, or after contacting the surface 314.

One or more features of the handheld spray gun 284 enable the spraying of a consistent, combined application 310 within a defined area 312, such as the size of first orifice 282 and/or the size of the second orifice 280 to adjust a rate of dispersion of the two liquids. Further, one or more adjustments to the components of each valve 260, chamber 262, and tip 264 may be utilized to increase or decrease an amount of adhesive or activator dispersed from the first nozzle 258 or second nozzle 256, thereby providing a threshold rate of dispersion to adequately combine the two liquids.

Accordingly, in embodiments of the invention, a first nozzle is coupled to a common bracket of a two-component, handheld spray gun at a particular angle relative to a second nozzle coupled to a common bracket of the two-component, handheld spray gun such that adhesive dispersed from the first nozzle intersects activator dispersed from the second nozzle to provide a combined spray pattern of mixed adhesive and activator. In embodiments, both adhesive and activator are propelled from the spray gun using only line pressure and are simultaneously dispersed from the tips of the corresponding nozzles based on activation of a common trigger. As such, in embodiments of the invention, using only line pressure, the two-component, handheld spray gun is configured to simultaneously disperse a consistent, combined amount of adhesive and activator from dual nozzles coupled to a common bracket and common trigger.

The present invention has been described in relation to particular embodiments, which are intended in all respects to be illustrative rather than restrictive. Alternative embodiments will become apparent to those skilled in the art to which the present invention pertains without departing from its scope.

It will be seen from the foregoing that this invention is one well adapted to attain the ends and objects set forth above and to attain other advantages, which are obvious and inherent in the device. It will be understood that certain features and subcombinations are of utility and may be employed without reference to other features and subcombinations. This is contemplated by and within the scope of the claims. It will be appreciated by persons skilled in the art that the present invention is not limited to what has been particularly shown and described hereinabove. Rather, all matter herein set forth or shown in the accompanying drawings is to be interpreted as illustrative and not limiting.

What is claimed:

1. A two-component, handheld spray gun apparatus comprising:
a common bracket;
a first nozzle coupled to the common bracket, the first nozzle comprising a first spray valve and a first orifice, wherein the first spray valve allows an amount of liquid adhesive to be dispersed from the first nozzle using only line pressure;
a second nozzle coupled to the common bracket, the second nozzle comprising a second spray valve and a second orifice, wherein the second spray valve allows an amount of liquid activator to be dispersed from the second tip using only line pressure; and
a trigger coupled to the first nozzle and the second nozzle,
wherein the first nozzle is positioned with respect to the second nozzle such that liquid adhesive dispersed from the first nozzle intersects the liquid activator dispersed from the second nozzle during spraying of the handheld spray gun.

2. The apparatus of claim 1, wherein the trigger is configured to simultaneously control the first spray valve and the second spray valve.

3. The apparatus of claim 1, wherein the line pressure that disperses the liquid adhesive and the liquid activator is constant.

4. The apparatus of claim 1, wherein a ratio of the amount of liquid adhesive to the amount of liquid activator is within a range of 3:1 and 7:1.

5. The apparatus of claim 4, wherein the ratio of the amount of liquid adhesive to the amount of liquid activator is 4:1.

6. The apparatus of claim 1, wherein the dispersed liquid adhesive intersects the dispersed liquid activator during spraying of the handheld spray gun to produce a combined application pattern of liquid adhesive and liquid activator covering a defined area.

7. A method for application of a liquid adhesive and a liquid activator using a two-component, handheld spray gun, the method comprising:
applying line pressure to a liquid adhesive and a liquid activator coupled to a handheld spray gun; and
simultaneously dispersing:
1) an amount of the liquid adhesive from a first nozzle of the handheld spray gun using only the line pressure, the first nozzle comprising a first spray valve and a first tip, and
2) an amount of the liquid activator from a second nozzle using only the line pressure, the second nozzle comprising a second spray valve and a second tip;
wherein the line pressure dispersing the liquid adhesive and the liquid activator is constant, and further wherein the dispersed liquid adhesive intersects the dispersed liquid activator during spraying of the handheld spray gun to produce a combined application pattern of liquid adhesive and liquid activator covering a defined area on a surface.

8. The method of claim 7, wherein a ratio of the amount of liquid adhesive to the amount of liquid activator is within a range of 3:1 and 7:1.

9. The method of claim 8, wherein one or more of a size of a first orifice of the first tip and a size of a second orifice of the second tip is adjusted to change the ratio of the amount of liquid adhesive to the amount of liquid activator.

10. The method of claim 8, wherein a trigger of the handheld spray gun simultaneously controls the first spray valve and the second spray valve.

11. The method of claim 10, wherein the trigger is coupled to the first spray valve and the second spray valve such that an amount of pressure applied to the trigger is applied to the first spray valve and the second spray valve.

12. A two-component, handheld spray gun apparatus comprising:
a common bracket;
a first nozzle coupled to the common bracket, the first nozzle comprising:
1) a first spray valve,
2) a first chamber coupled to the first spray valve, and
3) a first tip coupled to the first chamber, the first tip comprising a first orifice, wherein the first spray valve allows an amount of liquid adhesive to be dispersed from the first tip using only line pressure;
a second nozzle coupled to the common bracket, the second nozzle comprising:
1) a second spray valve,
2) a second chamber coupled to the second spray valve, and
3) a second tip coupled to the second chamber, the second tip comprising a second orifice, wherein the second spray valve allows an amount of liquid activator to be dispersed from the second tip using only line pressure; and
a trigger configured to simultaneously control the first spray valve and the second spray valve, wherein applying pressure to the trigger causes simultaneous dispersal of the amount of liquid adhesive and the amount of liquid activator;
wherein the first nozzle is positioned with respect to the second nozzle such that liquid adhesive dispersed from the first nozzle intersects liquid activator dispersed from the second nozzle during spraying of the handheld spray gun, and further wherein the dispersed liquid adhesive intersects the dispersed liquid activator during spraying of the handheld spray gun to produce a combined application pattern of liquid adhesive and liquid activator covering a defined area.

13. The apparatus of claim 12, wherein a ratio of the amount of liquid adhesive to the amount of liquid activator is within a range of 3:1 and 7:1.

14. The apparatus of claim 13, wherein one or more of a size of the first orifice of the first tip and a size of the second orifice of the second tip is adjusted to change the ratio of the amount of liquid adhesive to the amount of liquid activator.

15. The apparatus of claim 13, wherein one or more of the first spray valve and the second spray valve is adjusted to change the ratio of the amount of liquid adhesive to the amount of liquid activator.

16. The apparatus of claim 13, wherein the ratio of the amount of liquid adhesive to the amount of liquid activator is 4:1.

17. The apparatus of claim 12, wherein the line pressure that disperses the liquid adhesive and the liquid activator is constant.

18. The apparatus of claim 12, wherein the line pressure that disperses the liquid adhesive and the liquid activator is within a range of 1 to 100 PSI.

19. The apparatus of claim 18, wherein the line pressure that disperses the liquid adhesive and the liquid activator is 30 to 50 PSI.

20. The apparatus of claim 12, wherein producing a combined application pattern of liquid adhesive and liquid activator covering a defined area comprises 1) dispersing the liquid adhesive at a particular angle relative to the dispersed liquid activator and 2) dispersing the liquid adhesive and liquid activator at a particular line pressure, such that the liquid adhesive and liquid activator are combined prior to application to a surface.
